(19) United States
(12) Patent Application Publication
(10) Pub. No.: US 2026/0208477 A1
(43) Pub. Date: Jul. 23, 2026

(54) PRINTING UNIT WITH POSITIONING SYSTEM

(71) Applicant: BOBST LYON, Bron Cedex (FR)

(72) Inventors: Eric VERNAY, Orliénas (FR); Michel MOUCHON, Mions (FR)

(73) Assignee: BOBST LYON, Bron Cedex (FR)

(21) Appl. No.: 19/140,811

(22) PCT Filed: Dec. 14, 2023
(86) PCT No.: PCT/EP2023/085953

§ 371 Date: Jun. 18, 2025

(30) Foreign Application Priority Data
Dec. 28, 2022 (EP) 22315359.4

(51) Int. Cl. B41F 31/34; B41F 13/008; B41F 31/30; B41F 31/36; B41F 33/08; B41F 33/14

(52) U.S. Cl. CPC B41F 31/34; B41F 13/008; B41F 31/301; B41F 31/307; B41F 31/36; B41F 33/08; B41F 33/14; B41P 2213/71; B41P 2213/804

(57) ABSTRACT

The present invention relates to a printing unit (6) comprising a chassis (28) having a first and a second lateral frame portions (31a, 31b), the lateral frame portions being configured to respectively receive a first distal end portion (30a) and a second distal end portion (30b) of an anilox cylinder (14). The first and second distal end portions of the anilox cylinder comprise a coupling portion (34), and wherein the printing unit further comprises a positioning system (42) configured to position the coupling portion in a predetermined angular position. The predetermined angular position allows the extraction of the anilox cylinder from the printing unit. The positioning system comprises a linear locking arrangement (52) configured to provide a rotational displacement of the coupling portion.

### FIELD OF THE INVENTION

The present invention relates to an anilox positioning system for a flexographic printing module. Such an anilox positioning system may be used in a converting machine, such as a flexo-folder gluer machine, a rotary die-cutting machine, or a flexographic printing press machine.

### BACKGROUND

Converting machines can be used for printing sheets or producing packaging items, such as blanks or boxes made from paper, cardboard or plastics. Two common types of converting machines are rotary die-cutter machines and folder-gluer machines. These types of machines may be configured to produce blanks in the form of flat-packed or folding boxes. A converting machine in the form of a printing press can be configured to print sheets of cardboard or like.

These machines may be provided with a printing section, comprising a plurality of flexographic printing units. The flexographic printing units are positioned one after another in a direction of transportation, and each of the printing units may be configured to print with a different ink.

Such a printing unit comprises an anilox cylinder having an open cell structure on its circumferential surface. These cells absorb ink from a doctor blade chamber and transfer the ink further to a printing plate on the printing cylinder. As the cell structure is linked to the resolution and quantity of ink to be deposited on the blank, there is often a need to change the anilox cylinder when the type of blanks to be produced changes.

For instance, an anilox cylinder used for a print run comprising full-tone regions, namely large areas that are uniformly coated with ink, is not suitable for finer printworks that does not comprise significant full-tone regions.

Document EP3927551 discloses a mobile handling carriage and system. The mobile handling carriage is designed to extract an anilox cylinder from a flexographic printing assembly, displace the extracted anilox cylinder to a storage location and replace the extracted printing cylinder with a new anilox cylinder.

In order to extract the anilox cylinder, it needs to be positioned in a release position and be disengaged from drive means.

### SUMMARY

In view of the prior art, it is an object of the present invention to provide a positioning system for a printing unit to either allow a fully or partially automatic extraction of an anilox cylinder. It is thus desirable to provide a consistent and precise orientation of the anilox cylinder in the release position of the anilox cylinder.

This object is solved by a printing unit according to claim 1.

According to a first aspect of the present invention, there is provided a printing unit comprising a chassis having a first and a second lateral frame portions, the lateral frame portions being configured to respectively receive a first distal end portion and a second distal end portion of an anilox cylinder, the first and second distal end portions of the anilox cylinder comprising a coupling portion, and wherein the printing unit further comprises a positioning system configured to position the coupling portion in a predetermined angular position allowing the extraction of the anilox cylinder from the printing unit, and wherein the positioning system comprises an indexing disc and a linear locking arrangement, wherein the indexing disc is configured to move in unison with the coupling portion of the anilox cylinder, and comprises at least one engagement surface, and wherein the linear locking arrangement comprises a movable locking member configured to engage with the engagement surface and provide a rotational displacement of the indexing disc.

The invention is based on a realization that a mechanical stop can be provided such that the locking position of the anilox disc is reproducible.

In an embodiment, a first positioning device is configured to provide a first rotational displacement of the coupling portion and the positioning system is configured to provide a second and subsequent rotational displacement of the coupling portion. In an embodiment, a first positioning device is configured to provide a first rotational displacement of the coupling portion and the positioning system is configured to provide a second and subsequent rotational displacement of the coupling portion. The first positioning device may be a drive system of the anilox roll.

In an embodiment, the indexing disc comprises a first peripheral cutout forming the engagement surface, and wherein the movable locking member is configured to abut against the first peripheral cutout and provide the rotational displacement of the indexing disc.

In an embodiment, the blocking surface is connected to at least one lateral frame portion of the chassis, and wherein the movable locking member comprises:
a first contact surface configured to engage with the engagement surface of the indexing disc to provide the rotational displacement of the indexing disc and
a second contact surface configured to abut against the blocking surface, and wherein the rotational displacement of the indexing disc is configured to be stopped when the second contact surface of the movable locking member abuts against the blocking surface.

In an embodiment, the positioning system further comprises a sensing system configured to detect the angular position of the indexing disc, the sensing system comprises a sensor and a detection element, the detection element being located on or in the indexing disc, and wherein the sensing system is configured to provide a control signal to a control unit of the positioning system to displace the movable locking member upon detection of the detection element in a predefined angular position by the sensor, to provide the second rotational displacement of the coupling portion.

In an embodiment, the detection element is a cutout in the indexing disc.

In an embodiment, the positioning system comprises a piston actuator mounted on the lateral frame portion, and wherein the movable locking member is attached to the distal end of a piston rod of said piston actuator.

In an embodiment, the sensing system is configured to provide a start signal to the piston actuator when the sensing system issues the control signal.

In an embodiment, wherein the movable locking member comprises a slider which is slidably connected to a guide rail attached to the lateral side portion.

In an embodiment, the movable locking member has a roller configured to contact the indexing disc.

### BRIEF DESCRIPTION OF THE DRAWINGS

The invention will now be described with reference to the appended drawings, in which like features are denoted with the same reference numbers and in which:

FIG. 1a is a schematic view of a printing section;

FIG. 1b is a schematic diagram of a printing unit;

FIG. 2 is a schematic perspective view of a printing section with an integrated anilox changing carriage;

FIG. 3 is a schematic cross-sectional view of a coupling portion of an anilox cylinder;

FIG. 4 is a schematic perspective view of a lateral side portion of a printing unit chassis;

FIG. 5 is a schematic cross-sectional view of a positioning system according to an embodiment of the present invention; and

FIG. 6 is a schematic cross-sectional view of a positioning system in an extended position and according to an embodiment of the present invention.

### DETAILED DESCRIPTION

The present invention can be used in several types of printing and converting machines such as a flexo-folder gluer or a rotary die-cutter machine.

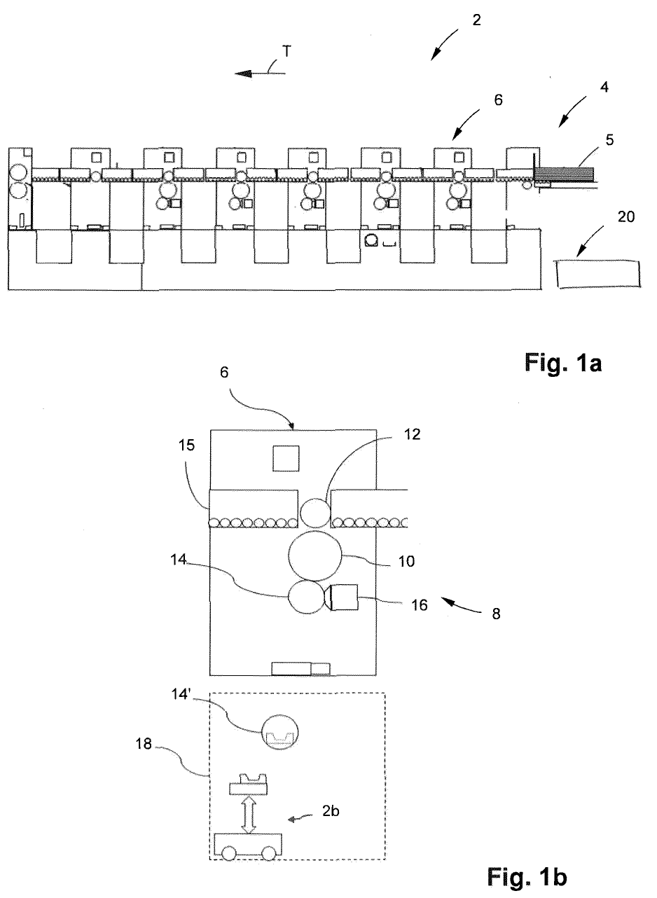

FIG. 1a illustrates a printing section 2 in a converting machine. The printing section 2 comprises a plurality of flexographic printing units 6 arranged one after the other in a direction of transportation T.

A feeder module 4 is located at an inlet portion to the printing section 2. The feeder module 4 is configured to feed sheet substrates 5 one by one in the direction of transportation T. The sheet substrates 5 may be rectangular or square sheets made from cardboard or paperboard, plastic or combinations thereof.

An example of a printing unit 6 is schematically illustrated in FIG. 1b. The printing unit 6 comprises a flexographic printing assembly 8 comprising a printing cylinder 10 configured to carry a printing plate, a counter cylinder 12, an anilox cylinder 14, and a doctor blade chamber 16. The printing unit 6 may further comprise a reserve station 18 for unused anilox cylinders 14′. The reserve station 18 is preferably located vertically below the flexographic printing assembly 8. The reserve station 18 comprises supports intended to support the ends of the anilox cylinders 14.

A main anilox storage station 20 may also be arranged under the feeder module 4. The main storage station 20 may be equipped with supports similar to those of the printing units 6. The main storage station 20 may have a larger storage capacity to than the reserve station 18.

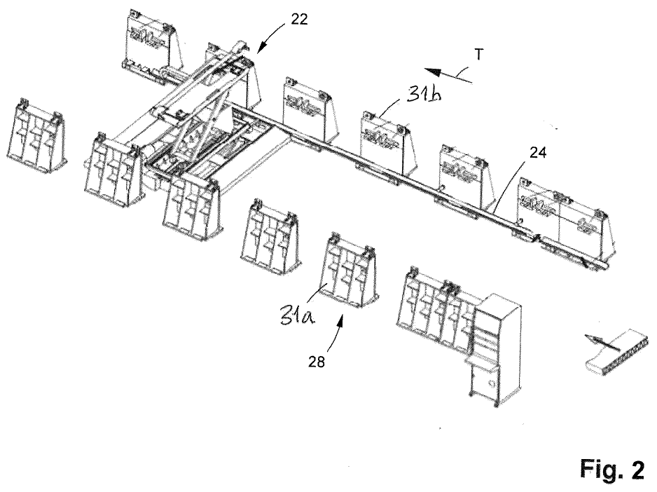

As illustrated in FIG. 2, a carriage 22 for handling anilox cylinders 14 may be integrated into the printing section 2. The carriage 22 is configured to automatically collect, change and displace anilox cylinders 14 between the flexographic printing assemblies 8, the reserve stations 18 and the main storage station 20.

The carriage 22 is mobile in a horizontal plane in the direction of transportation T, and is displaceable from the flexographic printing units 6 to the main storage station 20, downstream and upstream in the direction of transportation T.

The carriage 22 comprises a chassis, a support surface and one or more gripping members. The carriage 22 is movable along a guidance system comprising rails 24 extending in the direction of transportation T. Such a carriage and guidance system are disclosed in the document EP3927551.

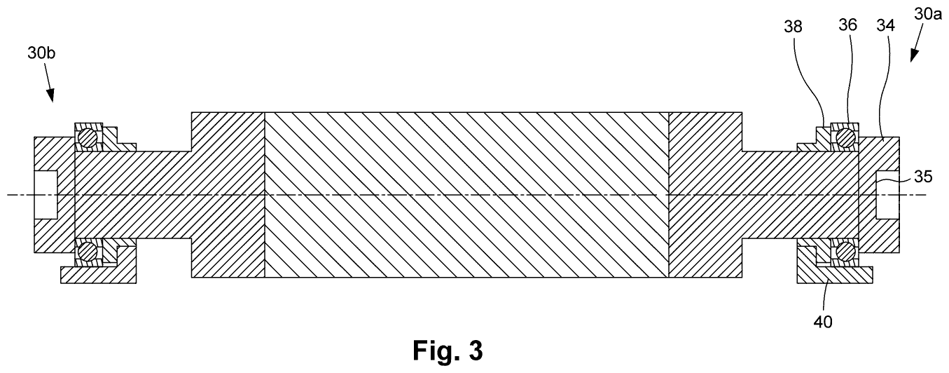

As best seen in FIGS. 2 to 4, the printing unit 6 comprises a chassis 28 to which the flexographic printing assembly 8 is attached. A first and a second distal end portions 30a, 30b of the anilox cylinder 14 are respectively received in a first and second lateral side portions 31a, 31b of the chassis 28.

The first and the second distal end portions 30a, 30b of the anilox cylinder 14 respectively comprise a coupling portion 34, a bearing 36 and a guide bracket 38. The coupling portion 34 allows a drive member in the printing unit 6 to drive the anilox cylinder 14 in rotation. The coupling portion 34 comprises a groove 35 configured to engage with the drive member M, which in turn is connected to a motor.

The carriage 22 is configured to connect its gripping members to the guide brackets 38 and pull the anilox cylinder 14 out from the printing unit 6. The guide brackets 38 comprise openings configured to receive gripping members in the form of latches from the carriage 22. The guide brackets 38 are received in a first and a second guide rails 40 connected to the lateral side portions 31a, 31b of the chassis 28. The guide brackets 38 are thus slidably received in the guide rails 40.

The guide rails 40 are further configured to support the distal end portions 30a, 30b of the anilox cylinder 14 as the anilox cylinder 14 is extracted from the chassis 28. In order to extract the anilox cylinder 14 from the chassis 28, the first and second coupling portions 34 need to be positioned in a release position.

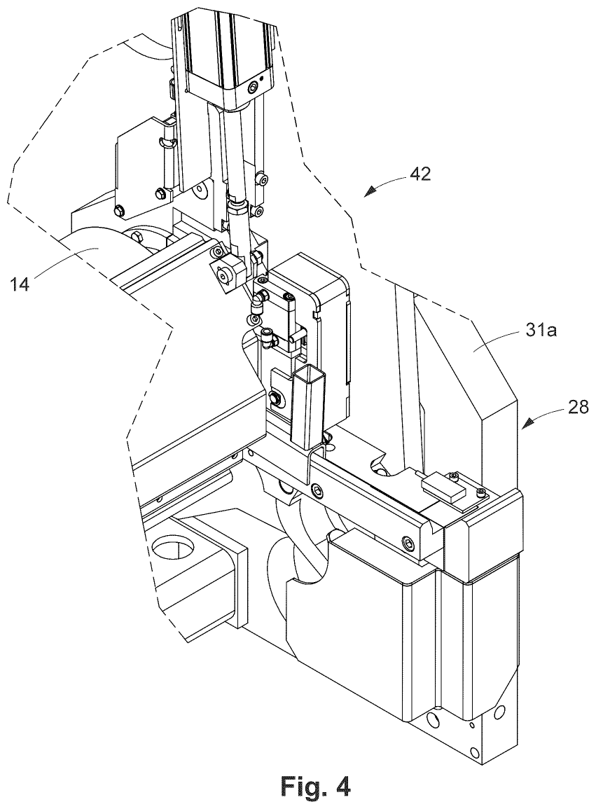

As best seen in FIGS. 4, 5 and 6, the printing unit 6 comprises a positioning system 42 configured to position the coupling portion 34 of the anilox cylinder 14 into a predetermined angular position, such that it can be extracted from the drive member in the printing unit 6. In this position, the groove 35 in the coupling portion 34 is horizontally positioned. This position is referred to as the release position.

The positioning system 42 is activated when the printing section 2 is stopped and the anilox cylinder 14 needs to be extracted from the printing unit 6.

The drive member of the anilox cylinder 14 is connected to the positioning system 42. In an extraction mode, the drive member M is configured to provide a controlled rotation of the anilox cylinder 14. The drive member M may be a motor.

According to the present invention, the present positioning system 42 comprises an indexing disc 44, a sensing arrangement 48 and a linear locking arrangement 52 The indexing disc 44 is operationally connected to the coupling portion 34. Consequently, when the indexing disc 44 is rotated, the coupling portion 34 effectuates the same rotation.

The sensing arrangement 48 comprises a sensor 49 and a detection element 50. The sensing arrangement is configured to detect the angular position of the indexing disc 44. Upon detection, the sensing arrangement 48 provides a control signal once the indexing disc 44 is in a predefined angular position. The sensing arrangement 48 may comprise a magnetic or an induction sensor 49 which is configured to sense a detection element 50 attached to or integrated into the indexing disc 44. The detection element 50 is an element which provide a change in the sensed material properties as captured by the sensor 49. For instance, the detection element may be a magnetic element.

The indexing disc comprises an engagement surface 60 configured to engage with a movable locking member 62. The engagement surface 60 may be in the form of a peripheral cutout 60. According to an alternative not shown, the engagement surface 60 may be in the form of an element attached to the lateral surface of the indexing disc 44.

Optionally, the indexing disc 44 may comprise a second cutout 61. The second cutout 61 may be identical to the first cutout 60 such that the indexing disc 44 is symmetrical about two central axes. In a preferred embodiment, the detection element 50 of the sensor 49 is the cutout 60 or 61.

The linear locking arrangement 52 is attached to a lateral side portion 31a of the chassis 28. The linear locking arrangement 52 comprises a movable locking member 62 which is attached to a cylinder rod 63 of an actuator 64. The actuator 64 may be a pneumatic or a hydraulic actuator. The movable locking member 62 has a first engagement portion 65a provided with a shape corresponding to the shape of the cutout 60 in the indexing positioning disc 44.

The movable locking member 62 is further provided with a second engagement portion 65b configured to abut against a stationary blocking surface 66. The stationary blocking surface 66 is mounted on the lateral side portion 31a of the chassis 28.

The second engagement portion 65b is provided with corresponding shape to the blocking surface 66. In the illustrated embodiment, the blocking surface 66 can be square, and the movable locking member 62 is provided with a corresponding square cutout.

The movable locking member 62 may be provided with a roller 67 at its distal end. The roller 67 allows a relative movement between the movable locking member 62 and the indexing disc 44.

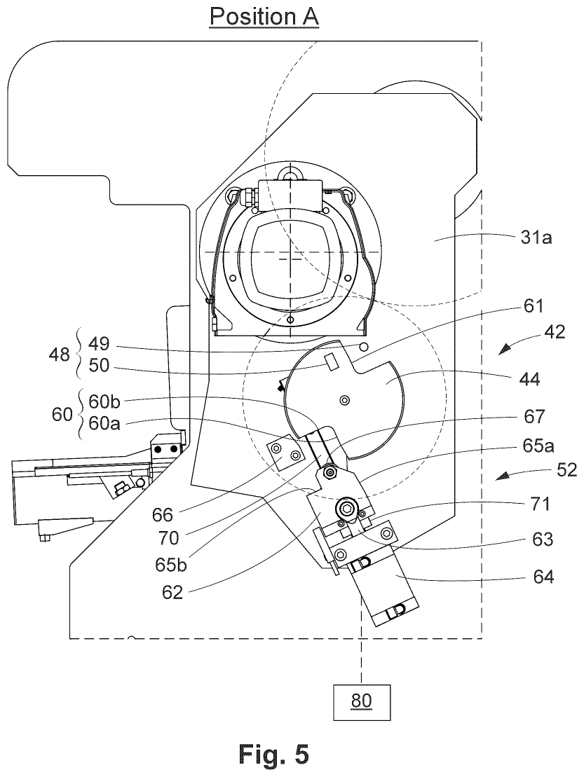

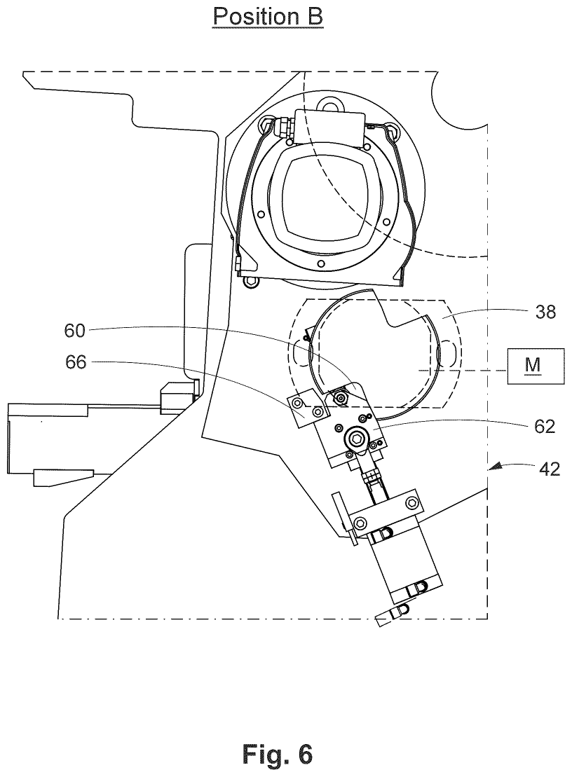

The linear locking arrangement 52 may further comprise a guide rail 70 attached to the lateral side portion 31a of the chassis 28. The movable locking member 62 comprises a corresponding slider 71 which is received in the guide rail 70. In such a way, the movable locking member 62 is guided and restricted in its movement. As illustrated in FIGS. 5 and 6, the movable locking member 62 is thus movable between a retracted position A and an extended position B. When the movable locking member 62 is in the extended position, the indexing disc 44 and coupling portion 34 are locked from further rotation. The extended position of the movable locking member 62 corresponds to the release position of the anilox cylinder 14. Hence, when the movable locking member 62 is in the extended position, the coupling portion 34 of the anilox cylinder 14 is positioned at an angle which allows a horizontal extraction of the anilox cylinder from the printing unit 6.

The sensing arrangement 48 is configured to detect the presence of the detection element 50 in (or on) the indexing disc 44. Alternatively, and preferably, the sensor 49 can be configured to sense the passage of the cutout 60 or 61 as the indexing disc 44 rotates. This detection position is an angular position of the indexing disc 44 and can be referred to as an “intermediate position”. The intermediate position is a position in which the indexing disc 44 is close to the release position.

The positioning system 42 further comprises a control unit 80 configured to receive a control signal from the sensing arrangement 48 and initiate the displacement of the movable locking element 62.

In the intermediate position, the movable locking member 62 is moved from its retracted position and towards its extended position. Before reaching the extended position, the movable locking member 62 enters into the cutout 60 of the indexing disc 44 and the first engagement portion 65a is brought into contact with the cutout in the indexing disc 44.

The movable locking member 62 and the cutout have cooperating geometries. The cutout may have a rectangular shape and the movable locking member 62 may have a shape allowing the movable locking member 62 to contact both lateral sides 60a, 60b of the cutout.

The movable locking member 62 then pushes onto the cutout 60 until the second engagement portion 65b of the movable locking member 62 contacts the stationary blocking surface 66.

Hence, the drive member is performing a first rotational displacement of the indexing disc 44 until the intermediate position is reached.

The drive member can be the same drive mechanism configured to rotate the anilox cylinder 14 during operation. However, when providing a positioning movement, the drive member is performing a slower and more controlled rotation of the indexing disc 44.

A subsequent second rotational movement is provided by the movable locking member 62 until the second engagement surface 65b of the movable locking member 62 engages with the stationary blocking surface 66. The movable locking member 62 both provides a rotary displacement and locks the indexing disc 44 in the against the blocking element 66.

1. A printing unit comprising a chassis having a first and a second lateral frame portions, the lateral frame portions being configured to respectively receive a first distal end portion and a second distal end portion of an anilox cylinder, the first and second distal end portions of the anilox cylinder comprising a respective coupling portion,
wherein the printing unit further comprises a positioning system configured to position the coupling portions in a predetermined angular position allowing the extraction of the anilox cylinder from the printing unit, and wherein the positioning system comprises an indexing disc and a linear locking arrangement
wherein the indexing disc is configured to move in unison with the coupling portion of the anilox cylinder and comprises at least one engagement surface, and
wherein the linear locking arrangement comprises a movable locking member configured to engage with the engagement surface and provide a rotational displacement of the indexing disc

2. The printing unit according to claim 1, wherein a first positioning device is configured to provide a first rotational displacement of the coupling portion, and the positioning system is configured to provide a second and subsequent rotational displacement of the coupling portion.

3. The printing unit according to claim 2, wherein the first positioning device comprises a drive member of the anilox cylinder.

4. The printing unit according to claim 1, wherein the indexing disc comprises a first peripheral cutout forming the engagement surface, and wherein the movable locking member is configured to abut against the first peripheral cutout and provide the rotational displacement of the indexing disc.

5. The printing unit according to claim 1, wherein a blocking surface is connected to at least one lateral frame portion of the chassis, and wherein the movable locking member comprises:
a first contact surface configured to engage with the engagement surface of the indexing disc to provide the rotational displacement of the indexing disc and
a second contact surface configured to abut against the blocking surface and wherein the rotational displacement of the indexing disc is configured to be stopped when the second contact surface of the movable locking member abuts against the blocking surface

6. The printing unit according to claim,
wherein the positioning system further comprises a sensing system configured to detect the angular position of the indexing disc, the sensing system comprises a sensor and a detection element the detection element being located on or in the indexing disc, and wherein the sensing system is configured to provide a control signal to a control unit of the positioning system to displace the movable locking member upon detection of the detection element in a predefined angular position by the sensor to provide the second rotational displacement of the coupling portion.

7. The printing unit according to claim 6, wherein the detection element is a cutout, in the indexing disc.

8. The printing unit according to claim 7, wherein the positioning system comprises a piston actuator mounted on one lateral frame portion and wherein the movable locking member-is attached to a distal end of a piston rod of said piston actuator

9. The printing unit according to claim 8, wherein the sensing system is configured to provide a start signal to the piston actuator when the sensing system issues the control signal.

10. The printing unit according to claim 9, wherein the movable locking member comprises a slider which is slidably connected to a guide rail attached to the lateral frame portion

11. The printing unit according to claim 1, wherein the movable locking member has a roller configured to contact the indexing disc.
